(19) United States
(12) Patent Application Publication
(10) Pub. No.: US 2011/0247936 A1
(43) Pub. Date: Oct. 13, 2011

(54) TECHNOLOGY FOR THE DEPOSITION OF ELECTRICALLY AND CHEMICALLY ACTIVE LAYERS FOR USE IN BATTERIES, FUEL CELLS AND OTHER ELECTROCHEMICAL DEVICES

(76) Inventor: Victor Stancovski, Groton, CT (US)

(21) Appl. No.: 13/082,358

(22) Filed: Apr. 7, 2011

Related U.S. Application Data
(60) Provisional application No. 61/322,863, filed on Apr. 11, 2010.

(51) Int. Cl. C25D 13/00; B05D 3/14; B05D 3/06; C25D 13/22; B05D 1/36

(52) U.S. Cl. 204/472; 204/477; 204/486; 427/470; 427/598; 427/600

(57) ABSTRACT

A process and method is described for the deposition of the enhanced chemical and electrochemical activity layers essential for the operation of a battery, fuel cell or other electrochemical devices like sensors.

A precise and well-calibrated combination of agents with specific values, like exterior electric fields (direct current (d.c.), alternative current (a.c.), variable magnetic fields, and acoustic/elastic fields are used in tailoring of interface properties essential for the operation of the device with enhanced properties.

This invention describes processes for doping the active interfaces in electrodes, leading to the enhancement of properties and to an increased degree of control via a synergistic combination of (any of the following): direct current (d.c.) field, variable alternative current (a.c.) field, variable acoustic/elastic field, variable magnetic field and a variation of the partial pressure of oxygen and/or other gases in the interior of the electrode deposition reactor.

This invention describes processes that achieve a combination of graded functionality and graded porosity ideal for the enhancement of the operation of batteries, fuel cells and electrochemical reactors, characterized by improved figures of merit.

### CROSSREFERENCE TO RELATED ACTIONS

This application claims the benefit of the U.S. Provisional Application No. 61 322863, filed on Apr. 11, 2010, which is incorporated herein in its entirety by reference.

### BACKGROUND

The US patent application number 2010 0141212, published on Jun. 10, 2010, which claims the benefit of the U.S. Provisional Application 61 120 478 filed on Dec. 7, 2008, describes a technology for the stimulation and intensification of interfacial processes, with relevance for many types of devices, such as batteries, fuel cells and other similar devices for energy storage and generation. An example of the latter, which is not intended to be limitative, is the zinc-air cell. Other devices that may benefit from the implementation of this technology are electrocatalytic reactors, materials synthesis and processing reactors, sensors, as well as any other devices dependent on interfacial mass and charge transfer for their operation. This application is fully incorporated here by reference.

It would be advantageous to tailor the state of the interfaces active in the interface-dependent mass and charge transfer processes towards such characteristics as to maximize the rate(s) of the most relevant rate-determining step(s) of the process.

Furthermore, it will be advantageous to create graded interfaces, i.e., interfaces with properties continuously variable in depth and in the other two dimensions. The overall goal of creating such a structure is to achieve a maximization of the volume or surface fraction of the zones where the slowest processes predominate, and to minimize the surface/volume fraction of the inert zones, whose role is mainly to mechanically support the active interfaces.

Grading can be done via depositing successive layers in adequate environments, under the influence of adequate external physical and chemically active agents. The role of these external agents is to tailor the local (nanoscale) physical and chemical properties of the interfaces subject to their action in the direction of the maximization discussed in the previous paragraph.

The method described here leads to an increase in the efficiency and the rates of interfacial mass and charge transfer reactions in the construction and operation of an electrochemical device (battery, fuel cell, chemical reactor with a catalytic/electrochemical component).

### SUMMARY

This invention refers to the deposition of the active layers essential for the operation of a battery, fuel cell or another electrochemical device through the application of techniques widely used in the semiconductor industry, with the difference that a precise combination of supplementary agents, like exterior electric fields like, e.g., direct current (d.c.), alternative current (a.c.), variable magnetic fields, and acoustic/elastic fields are used in the tailoring of the surface properties. The materials characteristics whose tailoring and optimization for electrochemical devices which are the object of the present invention are different from those of semiconducting devices.

This invention describes processes that achieve a combination of graded functionality and graded porosity ideal for batteries, fuel cells and electrochemical reactors.

This invention describes processes for doping the active interfaces in electrodes, leading to the enhancement of properties and to an increased degree of control via a synergistic combination of (any of the following): direct current (d.c.) field, variable alternative current (a.c.) field, variable acoustic/elastic field, variable magnetic field and a variation of the partial pressure of oxygen or other gases in the interior of the electrode deposition reactor.

### DETAILED DESCRIPTION OF THE PREFERRED EMBODIMENTS

The active layers that are the functionally critical elements of the chemical, electrochemical and sensing devices that are the object of this patent application are deposited via high productivity thick and thin film techniques.

For instance, a combination of thick film techniques such as electroless deposition, thermal spraying, sol-gel and other similar processes can be used for the deposition of one or both electrodes. By the same token, the electrodes can be created via a combination of thin film deposition processes: chemical vapor deposition, physical vapor deposition, plasma-assisted deposition, pulsed-laser deposition. The enumeration of the combinations and deposition techniques is not intended to be limitative.

According to the present method, a combination of two or more of the following agents, acting for an appropriate amount of time in the deposition reactor while the deposition process is under way, is used for atomic-scale tailoring of the composition and structure of the grain boundaries of the resulting electrodes: a constant or variable direct current field, a constant or variable alternative current (a.c.) field, a constant or variable acoustic/elastic field and a constant or variable magnetic field.

The partial pressure of oxygen and/or other gases in the deposition environment, whose diffusion in the first atomic-thickness layers may alter the electrical properties of the grain boundaries, is an important factor in improving the properties of the electrode.

Therefore, an added element of control on the properties of the electrodes is achieved via a close control of the partial pressure of oxygen (or another gas, according to the specific composition of the electrode) in the environment prevalent in the deposition reactor, owing to its strong influence on the composition and structure of grain boundaries.

A controlled gradient of properties in any direction can be achieved by the joint action of these techniques in any combination and for any duration during the deposition process.

The precise sequence of the types of fields, duration of the applied influence, combination of frequencies, combination of amplitudes and phase angles between different types of fields is described in an unambiguous manner by a matrix of characteristics we choose to call Melody Factor.

The evaluation of the physical properties of the electrodes built according to the methods described in this document can be done via impedance measurements, complex dielectric constant measurements, optic and electron-microscopic techniques, surface spectroscopy (ultraviolet to infrared), BET adsorption, porosimetry, as well as other techniques known to those skilled in the art.

According to the current invention, a method is described for depositing layers with increased activity in electrochemical processes.

Electrode 1 (cathode or anode) is created by the deposition on an electrolyte material (ionic conductor) of a supporting thick film of conducting or semiconducting material with controlled porosity. The deposition can be achieved via lithography, electroless deposition, electrophoresis etc. The influence of an exterior agent is exerted at this point, whose role is to create a gradient of composition and an internal electric field at the grain boundaries between the different layers.

A conductive layer is created on this supporting thick film via thin film deposition techniques (CVD, PVD), and the external agent action is exerted again, leading to an enhancement of the overall reactivity.

The external agent is any combination of a direct current (d.c.) field, an alternative current (a.c.) field, a variable acoustic/elastic field and/or a variable magnetic field, coupled with a controlled partial pressure in the environment of the gas(es) whose content determines the formation of junctions at the interfaces between the electrolyte, the supporting layer and the conducting layer.

Electrode 2 (anode or cathode, respectively) is similarly created by the deposition of a porous, reasonably contiguous film of a suitable conducting or semiconducting material, followed, similarly, by the deposition of a suitable electron-conducting material. Both depositions are done under the influence of external agents, described in the preceding paragraphs.

The monitoring and the evaluation of the efficiency of the activity increase can be done via impedance measurements, complex dielectric constant measurements or similar macroscopic measurements that evaluate the interfacial properties prevailing at the connections between the electrode and the electrolyte.

These examples are given for illustration purposes only, and are not intended to be limitations. Common to these examples is the implementation of the synergism of external fields and chemical gradients, leading to the formation of interfaces and layers with enhanced chemical activity, catalytic activity, sensing or activity in electrochemical processes. Different embodiments of chemical, catalytic, electrocatalytic reactors or of sensing devices can benefit from the implementation of this synergism.

Further, while the description given above refers to the invention, the description may include more than one invention.

What is claimed is:

1. A method for the deposition of layers with increased activity in electrochemical processes essential for the operation of batteries, fuel cells, electrochemical reactors, consisting of depositions of layer of suitable materials done via thin and thick film techniques, under the influence of external agents defined as any specific combination of a direct current (d.c.) field of a given value, an alternative current (a.c.) field of a given value, an acoustic/elastic field of a given value and/or a variable magnetic field of a given value.

2. The method of claim 1, coupled with a specific time succession of the values of a well-controlled partial pressure in the environment surrounding the electrodes, of the gas(es) whose partial pressure as a function of time determines the formation of junctions at the interfaces between the electrolyte, the supporting layer and the conducting layer.

3. The methods of claims 1 and 2, in which the precise succession and the exact values of the parameters describing the fields, the time variation of the fields, the gas compositions in function of time, describing the environment in the deposition reactor are contained in a detailed matrix of values versus time, called the Melody Factor.
